(19) United States
(12) Patent Application Publication
(10) Pub. No.: US 2019/0302495 A1
(43) Pub. Date: Oct. 3, 2019

(54) LIQUID CRYSTAL MODULE

(71) Applicant: SHARP KABUSHIKI KAISHA, Sakai City (JP)

(72) Inventor: KOHSHIROH TANIIKE, Sakai City (JP)

(21) Appl. No.: 16/370,131

(22) Filed: Mar. 29, 2019

(30) Foreign Application Priority Data
Apr. 2, 2018 (JP) 2018-070952

(51) Int. Cl. G02F 1/1333; G02F 1/1337; C09K 19/56

(52) U.S. Cl. CPC G02F 1/1333; G02F 2001/133397; C09K 19/56; G02F 1/133711

(57) ABSTRACT

The present invention provides a liquid crystal module capable of reducing image sticking even in long-term use. The liquid crystal module includes, in the following order from a back surface side, a backlight configured to emit light including visible light, a polarizing plate, a first substrate, a liquid crystal layer, and a second substrate, the liquid crystal module further including: a heat-insulating layer at least at one position selected from between the backlight and the polarizing plate and between the polarizing plate and the first substrate; and an alignment film containing an azobenzene group on a liquid crystal layer side of at least one of the first substrate or the second substrate.

### CROSS-REFERENCE TO RELATED APPLICATIONS

The present application claims priority under 35 U.S.C. § 119 to Japanese Patent Application No. 2018-070952 filed on Apr. 2, 2018, the contents of which are incorporated herein by reference in their entirety.

### BACKGROUND OF THE INVENTION

### Field of the Invention

The present invention relates to liquid crystal modules. More specifically, the present invention relates to a liquid crystal module including a liquid crystal panel with a photo-alignment film and a backlight.

### Description of Related Art

Liquid crystal modules (also referred to as liquid crystal displays or liquid crystal display devices) are display devices utilizing a liquid crystal material to provide display. A typical display method therefor includes irradiating a liquid crystal panel including a pair of substrates and a liquid crystal layer between the substrates with light from a backlight (BL), and applying voltage to the liquid crystal material in the liquid crystal layer to change the alignment of the liquid crystal compounds (liquid crystal molecules), thereby controlling the amount of light transmitted through the liquid crystal panel.

There are known liquid crystal modules including a backlight. For example, JP H04-62520 A discloses a liquid crystal display that irradiates a liquid crystal element with light from a backlight unit, wherein a heat-diffusing plate or a heat-absorbing plate is disposed between the backlight unit and the liquid crystal element. JP 2008-145890 A discloses a liquid crystal display module including a liquid crystal display element and a backlight. The module includes a light-diffusing sheet stacked on the front surface side of the backlight, wherein the light-diffusing sheet contains a near-infrared absorber and has a near-infrared transmittance of 50% or lower. WO 2008/059703 discloses a liquid crystal display device including a liquid crystal panel and a backlight. The device includes a near-infrared region absorbing member which absorbs light in a near-infrared region of 900 nm to 1100 nm, the near-infrared region absorbing member being provided at least either in the liquid crystal panel or between the liquid crystal panel and the backlight.

Between each of the pair of substrates and the liquid crystal layer in the liquid crystal module is provided an alignment film configured to control the alignment of liquid crystal compounds with no voltage applied. A widely used method for alignment treatment for an alignment film is rubbing, which rubs a surface of the alignment film with a roller, for example. Instead of the rubbing, another alignment treatment technique, photo-alignment, has widely been developed, which irradiates the surface of the alignment film with light. The photo-alignment enables alignment treatment without contact with the surface of the alignment film, and is therefore more advantageous than the rubbing in reducing stain, dust, and other defects during the alignment treatment. An alignment film having been subjected to alignment treatment by photo-alignment is also referred to as a photo-alignment film.

There are known techniques for photo-alignment films. For example, WO 2016/017535 discloses a liquid crystal display device including, in the following order from a back surface side: a backlight that emits light including visible light; a linear polarizer; a first substrate; an alignment film; a liquid crystal layer that contains liquid crystal molecules; and a second substrate, the alignment film containing a material with an azobenzene structure that exhibits absorption anisotropy to visible light and isomerizes upon absorption of visible light, the linear polarizer having a polarized light transmission axis that intersects a direction in which the alignment film has larger absorption anisotropy. JP H11-218765 A discloses an alignment method for a polymer thin film including moieties alignable under linearly polarized light and having a glass transition temperature of 200° C. or higher, the method including irradiating the polymer thin film with linearly polarized light in the state where the alignable moieties are easily movable.

### BRIEF SUMMARY OF THE INVENTION

Before shipment, liquid crystal modules are tested under conditions close to the most severe environment in actual use, for quality verification. Liquid crystal modules are used in various applications, and are required to have different qualities in different applications and use environments. For example, automotive liquid crystal display devices, which are to be used for a longer period of time than mobile liquid crystal display devices such as smartphones and tablet computers, are required to work efficiently during long-term use, i.e., to have long-term reliability. Automotive liquid crystal display devices may also be used in a high-temperature environment, and are therefore required to have long-term reliability at high temperatures as well. The long-term reliability at high temperatures can be evaluated by a testing method such as the thermal shock test or the long-term image-sticking test. The thermal shock test includes changing the temperature of the liquid crystal panel constituting the liquid crystal display device to a low temperature and a high temperature at certain intervals so as to place burden of temperature changes on the liquid crystal panel. The long-term image-sticking test includes heating the liquid crystal panel to a high temperature of about 80° C., for example, and irradiating the liquid crystal panel in the heated state with light from BL for a long period of time.

The alignment films (photo-alignment films) imparted with the alignment controlling force by the photo-alignment include alignment films having a photoreactive moiety. Studies made by the present inventor show that an alignment film having a decomposable photoreactive moiety may produce decomposition products when subjected to photo-alignment treatment, and the decomposition products may be observed as bright spots. The temperature range for automotive liquid crystal display devices in actual use is wide, which means that the temperature range in the thermal shock test is also wide; for example, the temperature may be dropped and raised between −40° C. and 85° C. With such a temperature range, the liquid crystal material repeatedly shrinks and expands intensely to undergo a volume change, even by about 10%, for example. In the thermal shock test, the repeating of shrinkage and expansion of the liquid crystal material seems to cause the decomposition products, which are dissolved in the liquid crystal layer at the production stage, to aggregate to be observed as bright spots.

The present inventor studied how to reduce bright spots in the thermal shock test. The inventor thereby found that an alignment film having azobenzene groups, which isomerize when irradiated with light, as photoreactive moieties produces no decomposition products even when irradiated with light such as ultraviolet rays in photo-alignment, and thus eliminates the bright spot issue. Meanwhile, although the alignment film having azobenzene groups produces no decomposition products under light such as ultraviolet light and thereby eliminates the bright spot issue, the alignment film may exhibit low alignment controlling force and cause image sticking in the long-term image-sticking test.

In response to the above issues, an object of the present invention is to provide a liquid crystal module capable of reducing image sticking even in long-term use.

The present inventor made studies on the cause of image sticking of a liquid crystal module including an alignment film having azobenzene groups in the long-term image-sticking test. FIG. 10 is a graph of absorbances of alignment films plotted against wavelength. In FIG. 10, the line A represents the absorbance of an alignment film having azobenzene groups, and the line B represents the absorbance of an alignment film having decomposable photoreactive moieties. The line B shows the result of an example using an alignment film having a photoreactive dominant wavelength of 254 nm. FIG. 10 shows that the alignment film having decomposable photoreactive moieties has no absorption in the visible light range, whereas the alignment film having azobenzene groups is reactive in a broad range including the visible light range.

Light emitted from the BL (backlight illumination) includes visible light, which is included in the absorption wavelength range of the alignment film having azobenzene groups. This seems to increase the chances of image sticking in the alignment film having azobenzene groups as compared with an alignment film having another photoreactive moiety in the long-term image-sticking test. The reason therefor is described below.

FIG. 11 is a graph showing changes in refractive index anisotropies of alignment films over aging time when the alignment films are aged while the polarization direction for the backlight was changed. FIG. 11 shows the results of photo-alignment treatment on alignment films having azobenzene groups at respective temperatures of ordinary temperature, 60° C., and 80° C. Also in FIG. 11, the refractive index anisotropy at each time point was normalized, with the refractive index anisotropy of the alignment film, having been subjected to photo-alignment treatment at ordinary temperature before aging (at Hour 0 of polarized light backlight irradiation), taken as 1.0000. The refractive index anisotropy of an alignment film increases as the exposure dose in the photo-alignment treatment increases, and then reaches saturation. The refractive index anisotropy used as the reference for the normalization above corresponds to the saturated refractive index anisotropy of the alignment film having been subjected to photo-alignment treatment at ordinary temperature. As shown in FIG. 11, although slightly different in behavior depending on the heating level in the photo-alignment treatment, the refractive index anisotropies of the alignment films increased to an extent from Hour 0 to Hour 250 where the polarization direction for the backlight was parallel to the polarization direction for the exposure device in the photo-alignment treatment, whereas the refractive index anisotropies of the alignment films significantly decreased from Hour 250 to Hour 500 where the polarization direction for the backlight was perpendicular to the polarization direction for the exposure device in the photo-alignment treatment. An alignment film having azobenzene groups shows more or less varying alignment performance due to aging caused by the backlight. Yet, when the polarization direction of polarized ultraviolet light in the photo-alignment treatment is different from the polarization direction for the backlight, the refractive index anisotropy of the alignment film significantly decreases. Also, an alignment film having azobenzene groups shows correlated refractive index anisotropy and alignment controlling force; as the refractive index anisotropy decreases, the alignment controlling force decreases. The decrease in the alignment controlling force seems to cause image sticking.

Azobenzene molecules (azobenzene groups) are in the ground state as trans-azobenzene molecules, which are in the most stable state. Thus, trans-azobenzene molecules alone are usually present. Cis-azobenzene molecules have a conformation excited under light, which is not in a stable state, and thus cis-azobenzene is readily converted into the ground-state trans-azobenzene. In an alignment film immediately after being formed on a substrate, many irregular trans-azobenzene molecules randomly oriented are present. When this alignment film is irradiated with specific polarized light, trans-azobenzene molecules whose major axis direction is perpendicular to the specific polarized light do not react to the light (they do not absorb the light because the transition moment thereof is different), but trans-azobenzene molecules whose major axis is not perpendicular to the specific polarized light absorb the light, isomerizing into cis-azobenzene molecules. The cis-azobenzene molecules, which, however, are not in a stable state as described above, are immediately converted back to the trans-azobenzene molecules. If these trans-azobenzene molecules generated in the conversion are oriented to the direction perpendicular to the polarized light, they do not absorb the light any more, meaning that the trans-cis isomerization ends. In contrast, if the major axes of the generated trans-azobenzene molecules are not perpendicular to the specific polarized light, the trans-cis isomerization repetitively occurs. In this manner, almost all the azobenzene molecules are eventually oriented to (aligned in) the direction perpendicular to the polarization direction.

As described above, in the alignment film having azobenzene groups, trans-cis isomerization repetitively occurs under polarized ultraviolet light, and thereby the trans-azobenzene molecules aligned in the direction perpendicular to the polarization direction of the applied light become dominant, so that the anisotropy is imparted. When the alignment film having been subjected to the alignment treatment is irradiated with polarized light whose polarization direction is different from the polarization direction of the light applied in the photo-alignment treatment, some of the azobenzene groups undergo trans-cis isomerization again. This produces trans-azobenzene molecules oriented to a different direction from the trans-azobenzene molecules aligned in the photo-alignment treatment, producing alignment force in a direction different from the desired direction. For this reason, when the polarization direction of polarized ultraviolet light in the photo-alignment treatment is different from the polarization direction for the backlight, the refractive index anisotropy of the alignment film significantly decreases and thereby the alignment controlling force decreases. This is presumably how image sticking occurs.

The technique in WO 2016/017535 is described to reduce light absorption and isomerization of azobenzene and thereby reduce a decrease in refractive index anisotropy of the alignment film by disposing a linear polarizer such that its polarized light transmission axis crosses the absorption axis of the alignment film with a larger absorption anisotropy. However, this technique can still be improved in terms of image sticking reduction in long-term use. The reason therefor is described below.

The liquid crystal module includes a liquid crystal panel and a backlight. The liquid crystal panel includes a liquid crystal layer held between two polarizing plates whose transmission axes are perpendicular to each other. An alignment film is also disposed between the liquid crystal layer and each of the two polarizing plates.

The major axes of liquid crystal molecules in the liquid crystal layer are aligned in the same direction as the transmission axis of one of the polarizing plates with no voltage applied. Thus, the polarization direction of light from the backlight does not change and the light is not transmitted through the liquid crystal layer. In contrast, with voltage applied, the liquid crystal molecules rotate in a plane, and the birefringence of the molecules causes retardation in the liquid crystal cell. This rotates the polarization direction of light from the backlight, so that the light is transmitted through the liquid crystal layer. Hence, the polarization direction of the light from the backlight applied to the alignment film can vary. This technique in WO 2016/017535 can therefore still be improved in terms of image sticking reduction in long-term Use.

JP H04-62520 A suggests that heat can be evenly transferred to a liquid crystal element to eliminate temperature unevenness in the liquid crystal element, so that the display quality of a liquid crystal display can be improved. JP H04-62520 A, however, does not consider reduction of image sticking of the liquid crystal module including an alignment film having azobenzene groups in long-term use.

JP 2008-145890 A and WO 2008/059703 aim to prevent malfunction of a remote controlling system of a home appliance utilizing near-infrared rays, such as a television, due to near-infrared rays emitted from a light source in the backlight. JP 2008-145890 A and WO 2008/059703 do not consider reduction of image sticking of a liquid crystal module including an alignment film having azobenzene groups in long-term use.

JP H11-218765 A discloses that an azobenzene derivative can be used for a polymer thin film including moieties alignable under linearly polarized light and having a glass transition temperature of 200° C. or higher. JP H11-218765 A, however, does not consider reduction of image sticking of a liquid crystal module in long-term use.

FIG. 12 is a graph comparing changes with time in refractive index anisotropies of alignment films with or without reduction of heat dissipation from a backlight. FIG. 12 compares a mode (with reduced BL heat dissipation) including a heat-insulating layer between the backlight and the alignment film having azobenzene groups with a mode including no heat-insulating layer. The present inventor made more studies on reduction in refractive index anisotropy of the alignment film having azobenzene groups, and focused on a phenomenon that the image sticking unfortunately becomes more noticeable in a long-term image-sticking test as the luminance of light from the BL increases. The inventor then found that, as shown in FIG. 12, not only the illuminance provided by the BL but also heat dissipation from the BL contribute to this phenomenon, and the alignment film having azobenzene groups is unfortunately vulnerable not only to polarized light but also to heat. In trans-cis isomerization of azobenzene groups, trans-azobenzene molecules in the ground state are excited under light and converted into cis-azobenzene molecules. Here, heat seems to accelerate the trans-cis isomerization. The present inventor thereby found that reducing transfer of heat dissipated from the BL to the alignment film having azobenzene groups enables reduction of changes with time in refractive index anisotropy, completing the present invention.

In other words, an aspect of the present invention may be a liquid crystal module including, in the following order from a back surface side, a backlight configured to emit light including visible light, a polarizing plate, a first substrate, a liquid crystal layer, and a second substrate, the liquid crystal module further including: a heat-insulating layer at least at one position selected from between the backlight and the polarizing plate and between the polarizing plate and the first substrate; and an alignment film containing an azobenzene group on a liquid crystal layer side of at least one of the first substrate or the second substrate.

The heat-insulating layer may include at least one layer selected from the group consisting of a heat-absorbing filter, an air layer, an inert gas layer, and a vacuum layer.

The present invention can provide a liquid crystal module capable of reducing image sticking even in long-term use.

### BRIEF DESCRIPTION OF THE DRAWINGS

FIG. 1 is a schematic cross-sectional view of a liquid crystal module of an embodiment.

FIG. 2 is a schematic perspective view of the liquid crystal module of the embodiment.

FIG. 3A is a perspective view schematically showing the state where black display is provided on the liquid crystal module.

FIG. 3B is a superposed view of the alignment azimuth of a liquid crystal molecule, the transmission axes of first and second polarizing plates, and the vibration direction of light transmitted through a liquid crystal layer.

FIG. 4A is a perspective view schematically showing the state where white display is provided on the liquid crystal module.

FIG. 4B is a superposed view of the alignment azimuth of a liquid crystal molecule, the transmission axes of the first and second polarizing plates, and the vibration direction of light transmitted through the liquid crystal layer.

FIG. 5 is a block diagram showing a process of testing a substrate with an alignment film in Example 1.

FIG. 6 is a schematic view showing the state where the substrate with an alignment film in Example 1 is irradiated with polarized backlight illumination.

FIG. 7 is a graph showing changes with time in refractive index anisotropies of alignment films when substrates with an alignment film in Example 1 and Comparative Example 1 are irradiated with polarized backlight illumination.

FIG. 8 is a block diagram showing a process of testing a substrate with an alignment film in Example 2.

FIG. 9 is a graph showing changes with time in refractive index anisotropies of alignment films when substrates with an alignment film in Example 2 and Comparative Example 2 are irradiated with polarized backlight illumination.

FIG. 10 is a graph of absorbances of alignment films plotted against wavelength.

FIG. 11 is a graph showing changes in refractive index anisotropies of alignment films over aging time when the alignment films are aged while the polarization direction for the backlight was changed.

FIG. 12 is a graph comparing changes with time in refractive index anisotropies of alignment films with or without reduction of heat dissipation from a backlight.

### DETAILED DESCRIPTION OF THE INVENTION

Hereinafter, an embodiment of the present invention is described. The embodiment, however, is not intended to limit the scope of the present invention, and modifications may appropriately be made within the spirit of the present invention. Like reference numerals below designate identical components or components having a similar function throughout the drawings, and description of each component is not repeated. The configurations in the embodiment may appropriately be combined or modified within the spirit of the present invention.

### Embodiment

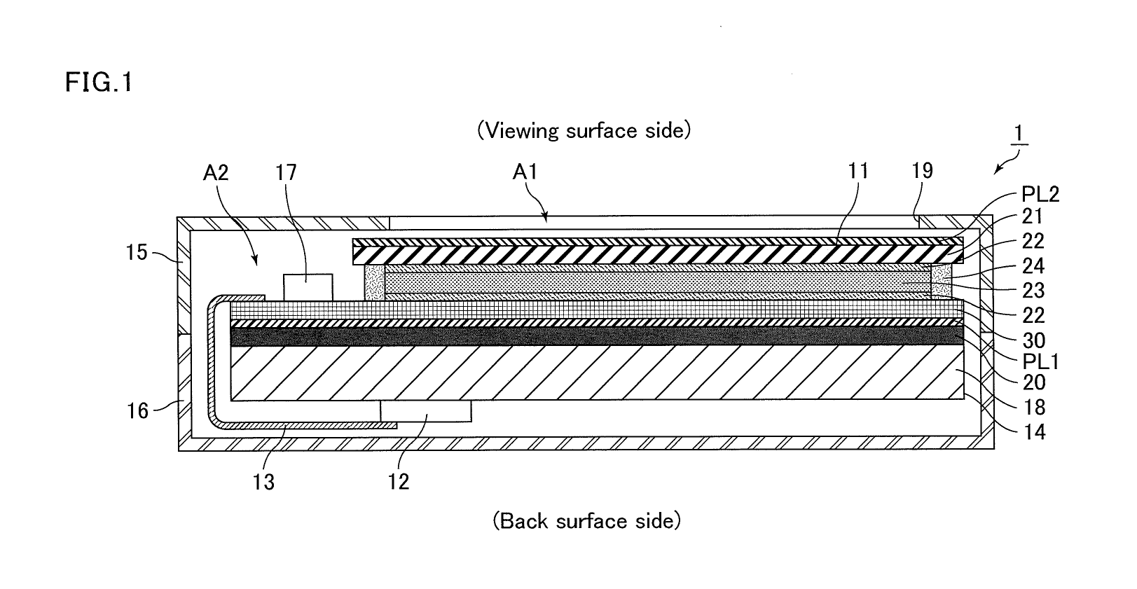

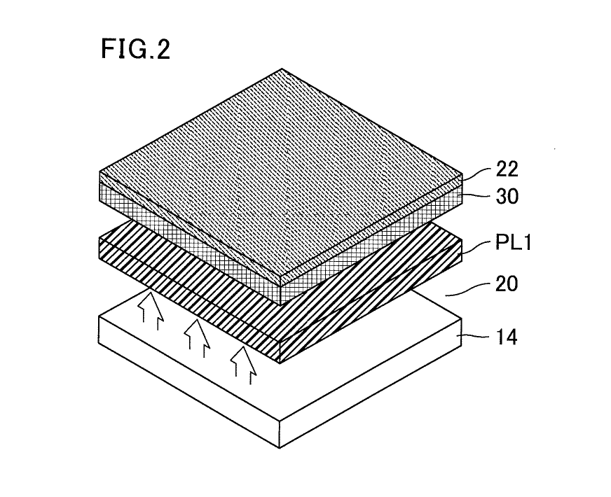

In the present embodiment, an in-plane switching (IPS) mode liquid crystal module is described as an example which aligns liquid crystal molecules having positive or negative anisotropy of dielectric constant in the direction parallel to a substrate surface to generate a transverse electric field in the liquid crystal layer. FIG. 1 is a schematic cross-sectional view of a liquid crystal module of an embodiment. FIG. 2 is a schematic perspective view of the liquid crystal module of the embodiment.

A liquid crystal module 1 of the present embodiment includes, in the following order from a back surface side, a backlight 14 configured to emit light including visible light (e.g., light having a wavelength of 400 to 800 nm), a heat-insulating layer 20, a polarizing plate (hereinafter, also referred to as a first polarizing plate) PL1, a first substrate 30, a liquid crystal layer 23, and a second substrate 21. Alignment films 22 containing azobenzene groups are disposed on the respective liquid crystal layer 23 sides of the first substrate 30 and the second substrate 21.

Unlike in the polarized light exposure (polarized light irradiation) process in photo-alignment treatment, light emitted from the backlight includes light with a polarization direction which is not desired to be included in light to be applied (i.e., light whose polarization direction is different from the polarization direction of the light applied in photo-alignment treatment). Thus, when the alignment film having azobenzene groups is irradiated with light from the backlight in the long-term image-sticking test, trans-cis isomerization occurs to generate trans-azobenzene molecules oriented differently from the trans-azobenzene molecules aligned in the photo-alignment treatment. This decreases the refractive index anisotropy of the alignment film, causing image sticking. The image sticking becomes more noticeable as the luminance of the backlight increases. This is because an increase in luminance of the backlight leads to excessive heat load on the alignment film due to not only the illuminance provided by the backlight but also heat dissipated from the backlight, accelerating the trans-cis isomerization. This decreases the refractive index anisotropy of the alignment film, decreasing the alignment controlling force of the alignment film. Since the amount of heat generated by the backlight increases as the luminance of the backlight increases, the refractive index anisotropy of the alignment film decreases to cause image sticking. Thus, it is important to reduce heat applied to the alignment film having azobenzene groups in image sticking reduction.

In the present embodiment, the heat-insulating layer 20 is disposed between the polarizing plate PL1 and the backlight 14. This structure enables reduction of heat transferred from the backlight 14 to the alignment film 22 to reduce a decrease in refractive index anisotropy of the alignment film 22 due to trans-cis isomerization of azobenzene groups, thereby reducing image sticking of the liquid crystal module 1 in long-term use. The heat-insulating layer 20 in the present embodiment can also reduce heat load by heat dissipated from the backlight 14 not only on the alignment film 22 on the backlight 14 side of the liquid crystal layer 23 but also on the alignment film 22 on the side remote from the backlight 14 of the liquid crystal layer 23. This structure therefore can reduce a decrease in alignment controlling force of the alignment films 22 even when the pair of alignment films 22 are disposed with the liquid crystal layer 23 in between, effectively reducing image sticking of the liquid crystal module 1 in long-term use.

Since the photodecomposable photoreactive moiety hardly absorbs visible light, an alignment film having a photodecomposable photoreactive moiety is presumed not to easily cause image sticking due to a decrease in alignment controlling force of the alignment film under visible light. Also, an alignment film to be subjected to an alignment treatment other than the photo-alignment treatment (e.g., rubbing treatment) has no photoreactive moiety. Hence, an alignment film to be subjected to an alignment treatment other than the photo-alignment treatment seems to hardly cause image sticking due to a decrease in alignment controlling force of the alignment film under light.

The present embodiment is described in detail below.

The liquid crystal module 1 of the present embodiment has a structure in which a liquid crystal panel 11, a control circuit substrate 12, a flexible substrate 13, the backlight 14, a driver 17, and the heat-insulating layer 20 are surrounded by an upper exterior part 15 provided with an opening 19 and a lower exterior part 16. The liquid crystal module 1 includes the liquid crystal panel 11, the heat-insulating layer 20, and the backlight 14 in the given order from the viewing surface side, and includes a display region A1 in which an image is to be displayed and a non-display region A2 in which no image is to be displayed.

The liquid crystal panel 11 includes the first substrate 30 including thin film transistors (TFTs), the second substrate 21 including color filters (CFs), and the liquid crystal layer 23 held between the first substrate 30 and the second substrate 21. The first polarizing plate PL1 is disposed on the side remote from the liquid crystal layer 23 of the first substrate 30. The second polarizing plate PL2 is disposed on the side remote from the liquid crystal layer 23 of the second substrate 21. The space between the first substrate 30 and the second substrate 21 is maintained constant with a sealant 24. The respective alignment films 22 having azobenzene groups are disposed between the first substrate 30 and the liquid crystal layer 23 and between the second substrate 21 and the liquid crystal layer 23.

The first substrate 30 includes source lines, scanning lines crossing the source lines, and TFTs used as switching elements, and is also called a TFT (array) substrate. The first substrate 30 includes belt-shaped common electrodes and belt-shaped pixel electrodes alternately disposed. When voltage is applied between a common electrode and a pixel electrode, the alignment of liquid crystal molecules in the liquid crystal layer 23 is changed. Herein, the state where voltage is applied between a common electrode and a pixel electrode is also simply referred to as a “voltage applied state”, and the state where voltage is not applied between a common electrode and a pixel electrode is also simply referred to as a “no-voltage-applied state”.

The second substrate 21 includes a black matrix and color filters, and is also called a CF substrate.

The alignment films 22 each have a function to control the alignment of liquid crystal molecules in the liquid crystal layer 23. When the voltage applied to the liquid crystal layer 23 is lower than the threshold voltage (including application of no voltage), the alignment of liquid crystal molecules in the liquid crystal layer 23 is controlled mainly by the functions of the alignment films 22.

The alignment films 22 each have azobenzene groups. Azobenzene groups are photoreactive moieties that isomerize when irradiated with light. Thus, the alignment films 22 having azobenzene groups are photo-alignment films, which can be subjected to photo-alignment treatment. The azobenzene groups isomerize when absorbing some visible light rays (having a short wavelength).

The azobenzene groups in the alignment films 22 are each obtained by abstracting one or more hydrogen atoms from azobenzene. At least one hydrogen atom in each azobenzene group may be replaced.

Examples of the alignment films 22 having azobenzene groups include alignment films containing first polymers with an azobenzene group. The first polymers with an azobenzene group each preferably contain the azobenzene group in its main chain. This structure enables production of the alignment films 22 having stable alignment performance. This is presumably because the main chain structure can be directly changed by photoirradiation and the first polymers with an azobenzene group can be aligned, whereby the refractive index anisotropies of the obtained alignment films 22 increase significantly. Meanwhile, first polymers with an azobenzene group in a side chain may fail to stabilize the alignment performance of the resulting alignment films 22. The reason therefor is not clear, but is presumably that even if the side chains react to light, the main chains do not follow the reaction, failing to cause the first polymers with an azobenzene group to be aligned.

Examples of the first polymers with an azobenzene group include those having at least one structure selected from a polyamic acid structure, a polyimide structure, a polysiloxane structure, and a polyvinyl structure in their main chain. For excellent heat resistance and easy layer separation, the first polymers with an azobenzene group more preferably have in their main chain a polyamic acid structure and/or a polyimide structure. The ratio of amide groups and carboxy groups dehydrated and cyclized through imidization to all amide groups and carboxy groups in a polyamic acid before the imidization is referred to as an imidization ratio. Herein, the polyamic acid structure means one having an imidization ratio of lower than 50%, and the polyimide structure means one having an imidization ratio of 50% or higher. A polyacrylic structure, which decomposes at a high temperature, limits the baking temperature, and is therefore not preferred to be used together with the azobenzene group. The first polymers with an azobenzene group preferably do not have a polyacrylic structure in their main chain. In the case where the alignment films are designed to have the later-described bi-layer structure, the first polymers with an azobenzene group preferably have no polyacrylic structure in their main chain as the polyacrylic structure does not easily cause layer separation and does not easily give stable alignment performance.

The alignment film 22 may have a bi-layer structure including a photo-alignment layer that contains the first polymer with an azobenzene group and is positioned on the liquid crystal layer 23 side surface and a base layer that contains a second polymer other than the first polymer with an azobenzene group and is disposed on the surface remote from the liquid crystal layer 23. The photo-alignment layer is in contact with the liquid crystal layer 23 and functions to determine the alignment direction of liquid crystal molecules 231 in the liquid crystal layer 23 and the strength of the alignment (anchoring). The base layer is a lower layer in the alignment film 22 and functions to retain a high voltage holding ratio (VHR) of the liquid crystal layer 23 and enhance the reliability of the liquid crystal module 1. The alignment film 22 having the bi-layer structure can give the liquid crystal module 1 having excellent alignment controlling force and high reliability.

The second polymer may be any one usually used in the field of liquid crystal modules, and can be selected as appropriate in consideration of layer separation from the first polymer with an azobenzene group. The second polymer may contain no photoreactive moiety or may contain no side chain used to impart the alignment controlling force.

The second polymer preferably has in its main chain a polyamic acid structure, a polyimide structure, a polysiloxane structure, or a polyvinyl structure, for example, more preferably a polyamic acid structure and/or a polyimide structure.

The ratio by weight of the first polymer with an azobenzene group to the second polymer in the alignment film 22 may be 2:8 to 8:2. In formation of the alignment film 22 using an alignment film material (alignment film composition) containing the first polymer with an azobenzene group and the second polymer, a large amount of the first polymer with an azobenzene group increases the exposure amount required for reaction of the azobenzene groups in the exposure process. The increased exposure amount prolongs the exposure process. This may volatilize the solvent in the alignment film material, slowing down the reactivity of the first polymer with an azobenzene group. Thus, in consideration of the influence of the volatilization of the solvent, the amount of the first polymer with an azobenzene group in the alignment film 22 is preferably less than the amount of the second polymer. The ratio by weight of the first polymer with an azobenzene group to the second polymer in the alignment film 22 is more preferably 3:7 to 5:5.

The liquid crystal layer 23 may be any layer containing at least one type of liquid crystal molecules, and can be one usually used in the field of liquid crystal modules. The liquid crystal molecules may be of a negative liquid crystal material having negative anisotropy of dielectric constant Δε defined by the following formula or may be of a positive liquid crystal material having positive anisotropy of dielectric constant Δε.

Δε=(dielectric constant in major axis direction of liquid crystal molecule)−(dielectric constant in minor axis direction of liquid crystal molecule)

The heat-insulating layer 20 is positioned between the backlight 14 and the first polarizing plate PL1. In the present embodiment, the heat-insulating layer 20 is disposed between the backlight 14 and the first polarizing plate PL1 in consideration of the process where the liquid crystal panel 11 including the first polarizing plate PL1 and the backlight 14 are prepared, and these members are assembled into the liquid crystal module 1. Yet, the heat-insulating layer 20 may be disposed at any position where the heat-insulating layer 20 can reduce transfer of heat dissipated from the backlight 14 to the alignment film 22. For example, the heat-insulating layer 20 disposed between the first polarizing plate PL1 and the first substrate 30 can also reduce image sticking of the liquid crystal module in long-term use as in the present embodiment. In other words, the heat-insulating layer 20, regardless of whether being disposed on the backlight 14 side or the first substrate 30 side of the first polarizing plate PL1, can reduce image sticking of the liquid crystal module 1 at substantially the same level in long-term use.

Examples of the heat-insulating layer 20 include heat-absorbing type, heat-preventing type, and heat-blocking type heat-insulating layers.

Examples of the heat-absorbing type heat-insulating layer 20 include heat-absorbing filters (e.g., infrared-absorbing filters).

The heat-preventing type heat-insulating layer 20 can be a layer having a low heat conductivity, such as an air layer or an inert gas layer. The air layer preferably has a thickness of 1 mm to 3 mm, more preferably 1.5 mm to 2 mm. The inert gas used in the inert gas layer may be nitrogen or argon, for example, and is preferably nitrogen, more preferably argon. The inert gas layer preferably has a thickness of 1 mm to 3 mm, more preferably 1.5 mm to 2 mm. The air has a heat conductivity at ordinary temperature of 0.026 W/mK. Nitrogen has a heat conductivity at ordinary temperature of 0.026 W/mK. Argon has a heat conductivity at ordinary temperature of 0.017 W/mK. The heat conductivity of nitrogen is substantially the same as that of the air. The heat conductivity of argon is as low as about ⅔ of those of nitrogen and the air. An inert gas layer formed from argon is therefore considered to have higher heat insulation than an air layer and an inert gas layer formed from nitrogen. In the case where an inert gas layer is used as the heat-insulating layer 20, the inert gas layer can be one that is, for example, sealed with a transparent material and filled with inert gas with low heat conductivity, such as nitrogen or argon.

The heat-blocking type heat-insulating layer 20 can be a layer having substantially no heat conductivity, such as a vacuum layer. The vacuum layer preferably has a thickness of 0.5 mm to 1.5 mm, more preferably 0.8 mm to 1 mm. In the case where a vacuum layer is used as the heat-insulating layer 20, the vacuum layer can be one that is, for example, sealed with a transparent material with the sealed space being evacuated.

The heat-insulating layer 20 preferably has a visible light transmittance of 90% or higher. This can reduce a decrease in use efficiency of light from the backlight 14.

The first polarizing plate PL1 and the second polarizing plate PL2 are each preferably a linearly polarizing plate, and can be one usually used in the field of liquid crystal modules. The first polarizing plate PL1 and the second polarizing plate PL2 are preferably disposed such that their transmission axes are in crossed Nicols.

The backlight 14 includes a light source, a light-diffusing film, and a chassis 18. The backlight 14 emits light including visible light. The light source can be one usually used in the field of liquid crystal modules such as a light emitting diode (LED). The backlight 14 may be a direct-lit one or an edge-lit one.

The backlight 14 preferably has a luminance of 20,000 cd/m² or higher, more preferably 30,000 cd/m² or higher. The luminance, illuminance, and dissipation heat of the backlight are correlated with each other; as the luminance increases, the illuminance and dissipation heat increase. In the present embodiment, even with the backlight 14 having a luminance of as high as 20,000 cd/m² or higher, the heat-insulating layer 20 can reduce dissipation heat from the backlight 14, effectively reducing image sticking of the liquid crystal module 1. The upper limit of the luminance of the backlight 14 is not particularly limited, but is preferably 60,000 cd/m² or lower, more preferably 50,000 cd/m² or lower.

The backlight 14 may have on its surface a reflective polarization film (e.g., luminance increasing film from 3M, trade name: DBEF (Dual Brightness Enhancement Film)). The reflective polarization film is mainly used to increase the luminance (particularly front luminance), and enhances the heat stability (the heat stability here means uniform distribution of heat in a plane, not heat insulation). Since the reflective polarization film has polarization characteristics, the polarization direction thereof is preferably made the same as the polarization direction of the first polarizing plate PL1 bonded to the liquid crystal panel 11.

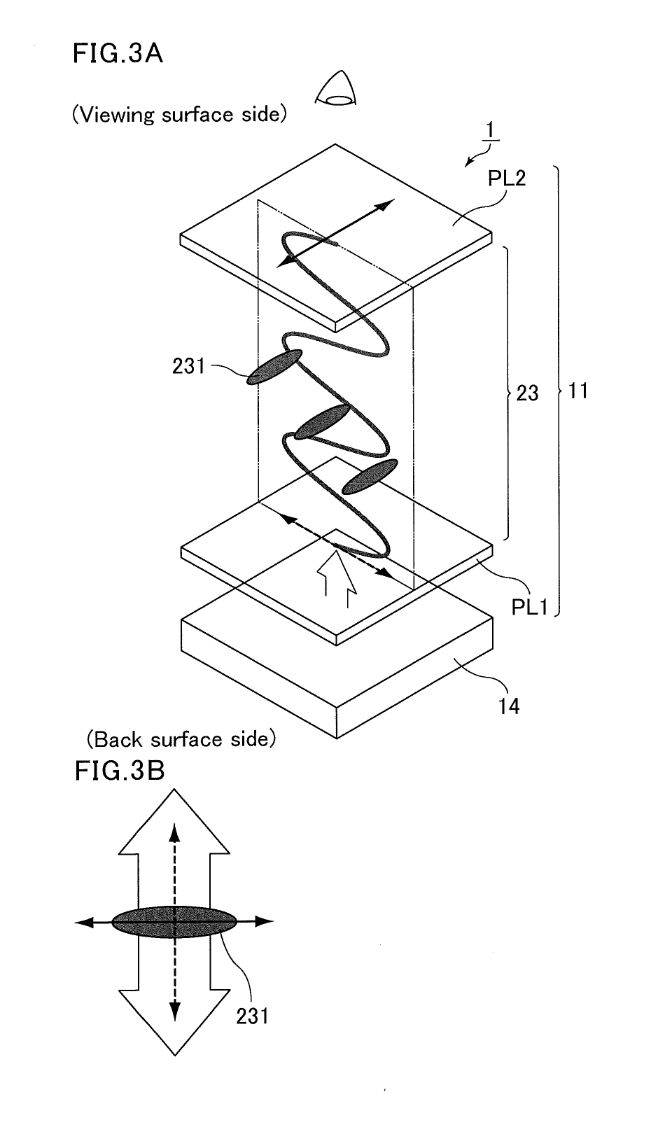

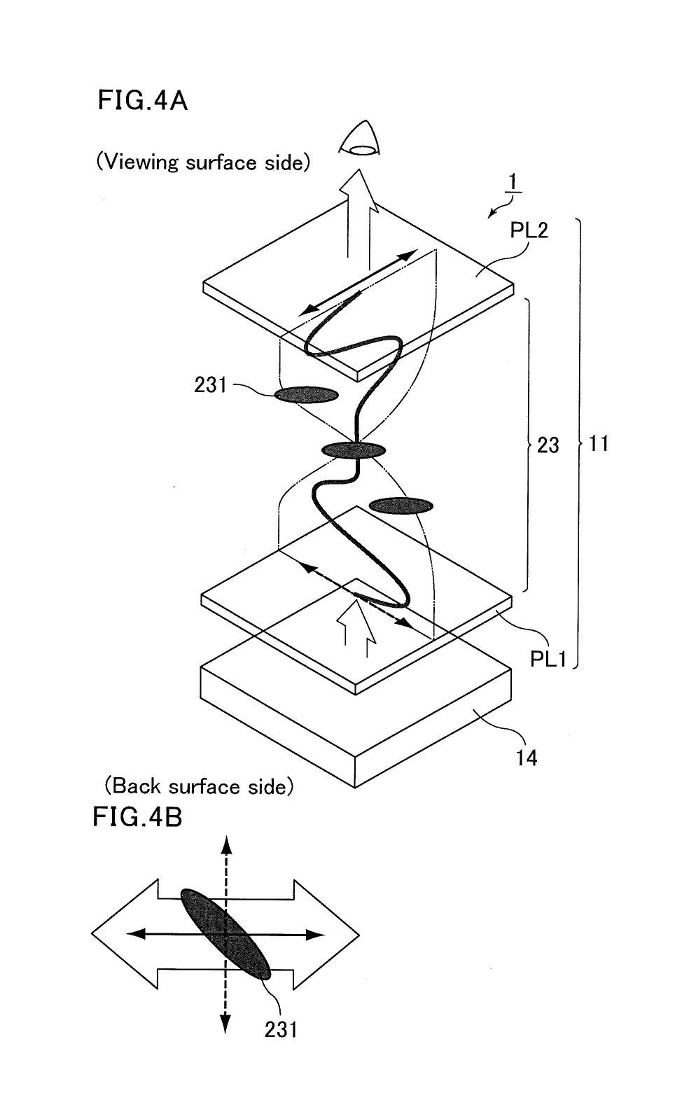

Hereinafter, the display method of the liquid crystal module 1 of the present embodiment is described with reference to FIG. 3A, FIG. 3B, FIG. 4A and FIG. 4B. FIG. 3A is a perspective view schematically showing the state where black display is provided on the liquid crystal module. FIG. 4A is a perspective view schematically showing the state where white display is provided on the liquid crystal module. FIG. 3B and FIG. 4B show superposed views of the alignment azimuth of a liquid crystal molecule, the transmission axes of the first and second polarizing plates, and the vibration direction of light transmitted through the liquid crystal layer, in observation from the second polarizing plate side in FIG. 3A and FIG. 4A, respectively. FIG. 3A and FIG. 4A do not show members other than the liquid crystal layer 23, the liquid crystal molecules 231, the first polarizing plate PL1, the second polarizing plate PL2, and the backlight 14, which constitute the liquid crystal panel 11, for convenience of description. Yet, the liquid crystal module has the same configuration as the liquid crystal module 1 shown in FIG. 1. In FIGS. 3A, 3B, 4A, and 4B, double-sided dashed arrows indicate the transmission axis of the first polarizing plate PL1, double-sided solid arrows indicate the transmission axis of the second polarizing plate PL2, and double-sided white arrows indicate the vibration direction (polarization direction) of light transmitted through the liquid crystal layer 23.

The vibration direction (polarization direction) of light incident on the liquid crystal layer 23 from the backlight 14 through the first polarizing plate PL1 is parallel to the transmission axis of the first polarizing plate PL1. As shown in FIGS. 3A and 3B, with no voltage applied to the liquid crystal layer 23, the polarization direction of light does not change in the liquid crystal layer 23. Therefore, the polarization direction of the light transmitted through the liquid crystal layer 23 remains perpendicular to the transmission axis of the second polarizing plate PL2, and thus the light is not transmitted through the second polarizing plate PL2. Hence, light from the backlight 14 is not emitted to the viewer's side, resulting in black display. In contrast, as shown in FIGS. 4A and 4B, with voltage applied to the liquid crystal layer 23, the liquid crystal molecules 231 rotate in the plane of the liquid crystal panel 11, so that the birefringence of the liquid crystal molecules 231 changes the retardation in the liquid crystal layer 23. Thereby, the polarization direction of light incident on the liquid crystal layer 23 rotates and thus the light is transmitted through the second polarizing plate PL2. Hence, light from the backlight 14 is emitted to the viewer's side, resulting in white display. Varying the magnitude of voltage applied to the liquid crystal layer 23 changes how much the liquid crystal molecules 231 rotate, enabling grayscale display. As shown in FIGS. 4A and 4B, the luminance becomes the highest when the polarization direction of light transmitted through the liquid crystal layer 23 is parallel to the transmission axis of the second polarizing plate PL2. The first polarizing plate PL1 and the second polarizing plate PL2 may be disposed in an opposite manner from that shown in FIG. 3 and FIG. 4.

### Modified Example 1 of Embodiment

In the above embodiment, the IPS mode liquid crystal module 1 was described in which belt-shaped pixel electrodes and belt-shaped common electrodes are alternately disposed on the first substrate 30. Yet, an FFS mode liquid crystal module 1 may be used in which planar pixel electrodes for the respective pixels, an insulating film, and a common electrode provided with slits are disposed sequentially on the first substrate 30. Also, an FFS mode liquid crystal module 1 may be used in which a planar common electrode, an insulating film, and pixel electrodes provided with slits are sequentially disposed on the first substrate 30.

Hereinafter, the present invention is described in more detail based on examples and comparative examples. The examples, however, are not intended to limit the scope of the present invention.

### Example 1

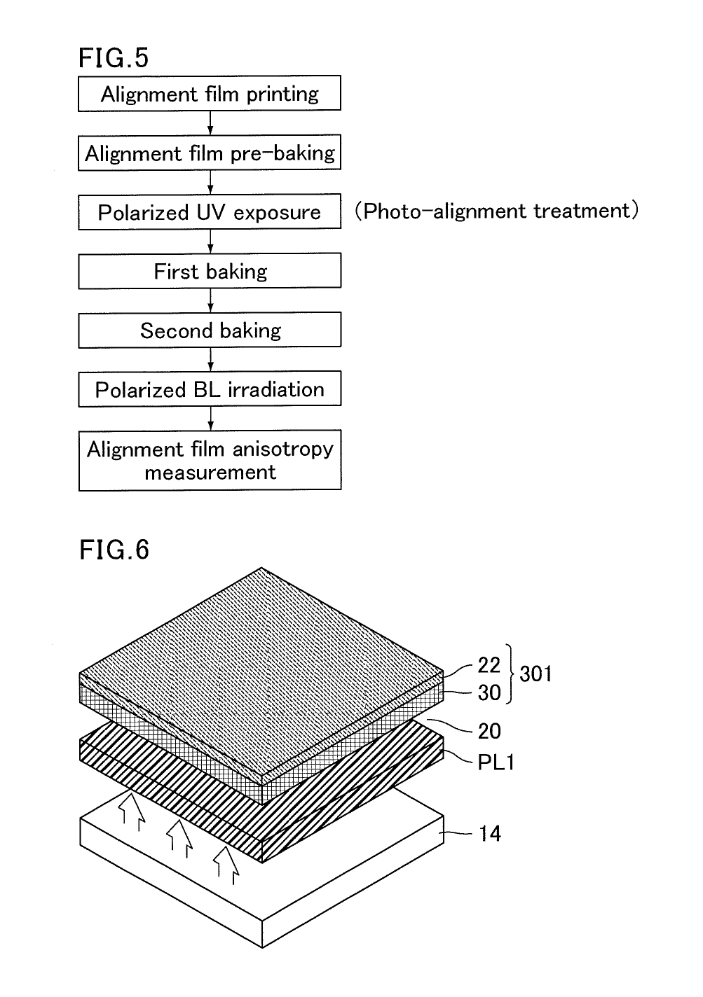

FIG. 5 is a block diagram showing a process of testing a substrate with an alignment film in Example 1. FIG. 6 is a schematic view showing the state where the substrate with an alignment film in Example 1 is irradiated with polarized backlight illumination. In accordance with the process of testing in FIG. 5, a substrate with an alignment film of Example 1 was produced as described below and the substrate was irradiated with polarized backlight illumination. The anisotropy of the alignment film was then measured. In application of the polarized backlight illumination, as shown in FIG. 6, a substrate 301 with an alignment film, the heat-insulating layer 20, the polarizing plate PL1, and the backlight 14 were disposed.

An alignment film material (also referred to as ink or varnish) was prepared which contained a polymer (first polymer) having an azobenzene group in its main chain and having a polyamic acid or polyimide structure, another polymer (second polymer) having no side chain for achievement of the alignment controlling force and having a polyamic acid or polyimide structure in its main chain, and a solvent. The alignment film material contained the first polymer and the second polymer at a ratio by weight of 3:7. The solvent used was a mixed solvent of N-methyl-2-pyrrolidone (NMP) and butyl cellosolve (BCS), and controlled to give a solids concentration of about 6%. The alignment film material was applied to a glass substrate by flexo printing, whereby a coating film was formed.

The glass substrate was placed on 1-mm pins on a hot plate (HP) whose temperature was set to 80° C., and they were retained in this state for 90 seconds for pre-baking. The actual substrate temperature was within the range of 60° C. to 70° C. including in-plane variations. The pre-baking uniformly volatilized the solvent.

The pre-baking is conducted for roughly two reasons. The level of drying should not be insufficient or excessive. One of the reasons for the pre-baking is that the layer separation of the alignment film is increased, and the other reason is that the flowability of molecules is maintained to some extent.

The former reason (layer separation is increased) is described first. The alignment film used in the present example has a bi-layer structure. The upper layer is a photo-alignment layer (also referred to as a photo layer; in the present example, a layer containing a polyamic acid or polyimide structure having an azobenzene group as the photo-alignment moiety) and plays an important role in determining the alignment direction and the alignment strength (anchoring) of liquid crystal to be injected later. The lower layer is the base layer and mainly functions to enhance the reliability (increase the voltage holding ratio).

The diluted solution of the alignment film material in the solvent contains these two components mixed randomly, and starts to cause layer separation when applied to the glass substrate. With a large amount of the solvent, the molecules have a significantly high fluidity, and thus the layer separation proceeds rapidly. The layer separation, if it is excessive, causes the photo layer to aggregate, leaving the base layer exposed on the surface. The base layer, however, has no function to align the liquid crystal molecules. Thus, excessive layer separation is not considered favorable, and the solvent needs to be evaporated quickly.

The latter reason (the flowability of molecules is maintained to some extent) is described. With the solvent completely evaporated, the flowability of molecules decreases, significantly deteriorating the photoreactivity in the later-described polarized ultraviolet light irradiation. The solvent therefore needs to be left in an amount enough to prevent deterioration of the photoreactivity. In order to achieve a favorable alignment film state at this point, at least the substrate temperature is preferably kept within the range of 50° C. to 80° C., and the drying time is preferably set within the range of 60 to 120 seconds. The process in the present example was performed in the best conditions achievable within those ranges.

The glass substrate was exposed to polarized ultraviolet light for photo-alignment treatment. The glass substrate was then subjected to first baking at 175° C. for 10 minutes in an infrared furnace (IR furnace), followed by second baking at 220° C. for 20 minutes in the IR furnace. Thereby, a substrate 301 with an alignment film of Example 1 including the alignment film 22 having azobenzene groups on the first substrate 30 was obtained. The first baking is performed to induce the re-alignment reaction of molecules in the alignment films (reaction in which molecules of the photo layer, which did not react under polarized ultraviolet light, are aligned in the same direction as the molecules reacted under polarized ultraviolet light and uniformly aligned) and increase the rigidity of the film. The optimal temperature for the first baking is different depending on the material used. The second baking is the final baking to accelerate the imidization reaction of the polyamic acid in the alignment film material.

The anisotropy of the alignment film was measured by the following procedure.

As shown in FIG. 6, the substrate 301 with an alignment film of Example 1, the polarizing plate PL1, and the backlight 14 were disposed. Here, spacers of about 2 mm were provided between the substrate 301 with an alignment film of Example 1 and the polarizing plate PL1, so that the air functioned as the heat-insulating layer 20. The substrate 301 with an alignment film of Example 1 was then irradiated with light from the normal direction. The retardation (Δnd) of transmitted light was measured at a predetermined time interval, and the obtained value was divided by the thickness (d) of the alignment film, so that the refractive index anisotropy (Δn) was calculated. The retardation (Δnd) was measured using “AxoScan FAA-3series” from Axometrics, Inc. The thickness was measured by contact surface measurement using a “fully automatic, highly accurate micro figure measurement device ET5000” from Kosaka Laboratory Ltd. The light source in the backlight 14 was an LED. The backlight 14 had a luminance of about 40,000 cd/m².

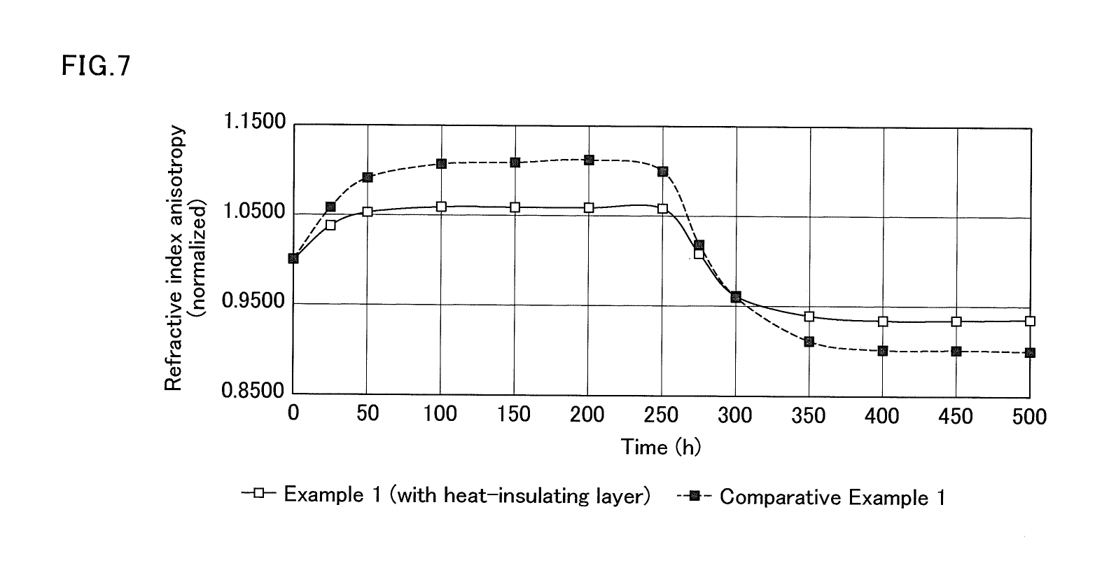

During irradiation time of the backlight illumination from Hour 0 to Hour 250, the polarization direction of the polarizing plate was set to match the polarized UV (ultraviolet light) irradiation direction of the alignment film, followed by rotation of the polarizing plate by 90°. During irradiation time of the backlight illumination from Hour 250 to Hour 500, the polarization direction of the polarizing plate was set to be perpendicular to the polarized UV irradiation direction of the alignment film. In the present test, the change with time in refractive index anisotropy of the alignment film under polarized backlight illumination was observed, and the same test was performed not only for the alignment film in Example 1 but also for the alignment films in the following Example 2 and Comparative Examples 1 and 2. For easy comparison of the changes with time in refractive index anisotropies, the refractive index anisotropies of the alignment films in Examples 1 and 2 and Comparative Examples 1 and 2 were normalized as follows. In other words, the refractive index anisotropy at each time point of each of the alignment films in Examples 1 and 2 and Comparative Examples 1 and 2 was normalized, with the refractive index anisotropy of the alignment film in Example 1 at Hour 0 under polarized backlight illumination taken as 1.0000, the alignment film having been subjected to photo-alignment treatment at ordinary temperature. The refractive index anisotropy of the alignment film in Example 1 increased as the exposure amount in the photo-alignment treatment increased, and then reached saturation. The refractive index anisotropy used as the reference for the normalization above corresponds to this saturated refractive index anisotropy of the alignment film. FIG. 7 is a graph showing changes with time in refractive index anisotropies of alignment films when substrates with an alignment film in Example 1 and Comparative Example 1 are irradiated with polarized backlight illumination. The results are shown in the following Table 1 and FIG. 7.

TABLE 1

| Elapsed time (h) | 0 | 25 | 50 | 100 | 150 | 200 | 250 | 275 | 300 | 350 | 400 | 450 | 500 |
|---|---|---|---|---|---|---|---|---|---|---|---|---|---|
| Comparative | 1.0000 | 1.0581 | 1.0911 | 1.1067 | 1.1087 | 1.1120 | 1.0997 | 1.0179 | 0.9598 | 0.9110 | 0.9012 | 0.9011 | 0.8999 |
| Example 1 | | | | | | | | | | | | | |
| Example 1 (with | 1.0000 | 1.0376 | 1.0526 | 1.0590 | 1.0589 | 1.0588 | 1.0581 | 1.0077 | 0.9610 | 0.9389 | 0.9338 | 0.9340 | 0.9351 |
| heat-insulating | | | | | | | | | | | | | |
| layer) | | | | | | | | | | | | | |

### Comparative Example 1

The anisotropy of a substrate with an alignment film of Comparative Example 1 was measured as in Example 1, except that no spacer was disposed between the substrate with an alignment film and the polarizing plate in measurement of the anisotropy of the alignment film. In other words, no heat-insulating layer was used in Comparative Example 1. Here, the temperature of the surface of the substrate with an alignment film of Comparative Example 1 was higher than the temperature of the surface of the substrate with an alignment film of Example 1 by about 10° C. to 15° C. The illuminance of the transmitted light from the backlight, i.e., the illuminance of the light emitted from the backlight and transmitted though the polarizing plate, on the surface of the substrate with an alignment film, in Example 1 was the same as that in Comparative Example 1. The results are shown in Table 1 and FIG. 7.

### Comparison Between Example 1 and Comparative Example 1

The change in refractive index anisotropy under polarized backlight illumination in Example 1 in which a heat-insulating layer was used was smaller than that in Comparative Example 1 in which no heat-insulating layer was used. In particular, the decrease in refractive index anisotropy was found to be reduced when the polarization direction for polarized UV exposure (polarized UV irradiation) in the photo-alignment treatment and the polarization direction of the polarized backlight irradiation were not the same. Here, a correlation was found between the refractive index anisotropy of the alignment film having azobenzene groups and image sticking; a higher refractive index anisotropy was found to cause less image sticking. Hence, in Example 1, image sticking was reduced even in long-term use.

In Example 1, the substrate 301 with an alignment film, the heat-insulating layer 20, the polarizing plate PL1, and the backlight 14 were disposed in the given order. Yet, the heat-insulating layer 20 may be at any position where the heat-insulating layer 20 can reduce transfer of heat dissipated from the backlight 14 to the substrate 301 with an alignment film. Thus, the same results as in Example 1 should be achieved even in the case where the positions of the heat-insulating layer 20 and the polarizing plate PL1 in Example 1 were switched such that the substrate 301 with an alignment film, the polarizing plate PL1, the heat-insulating layer 20, and the backlight 14 were disposed in the given order.

### Example 2

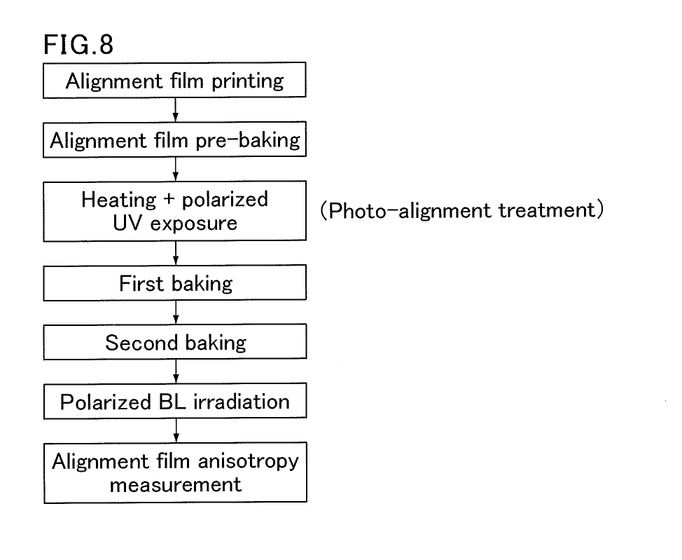

FIG. 8 is a block diagram showing a process of testing a substrate with an alignment film in Example 2. In accordance with the process of testing in FIG. 8, a substrate with an alignment film of Example 2 was produced as described below and the substrate was irradiated with polarized backlight illumination. The anisotropy of the alignment film was then measured. The process from printing of the alignment film onto the glass substrate to pre-baking of the alignment film is the same as that in Example 1 and description is not repeated here. In application of polarized backlight illumination, the substrate 301 with an alignment film, the heat-insulating layer 20, the polarizing plate PL1, and the backlight 14 were disposed as in Example 1 as shown in FIG. 6.

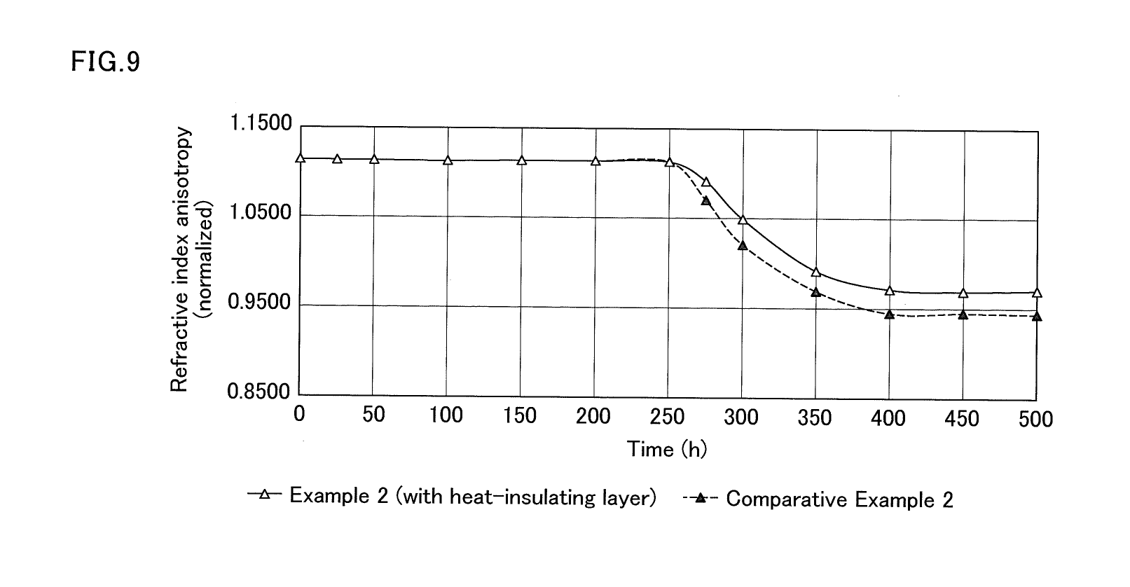

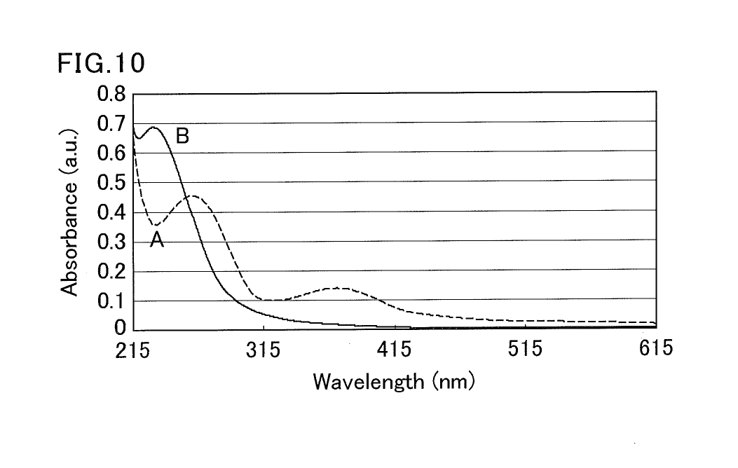

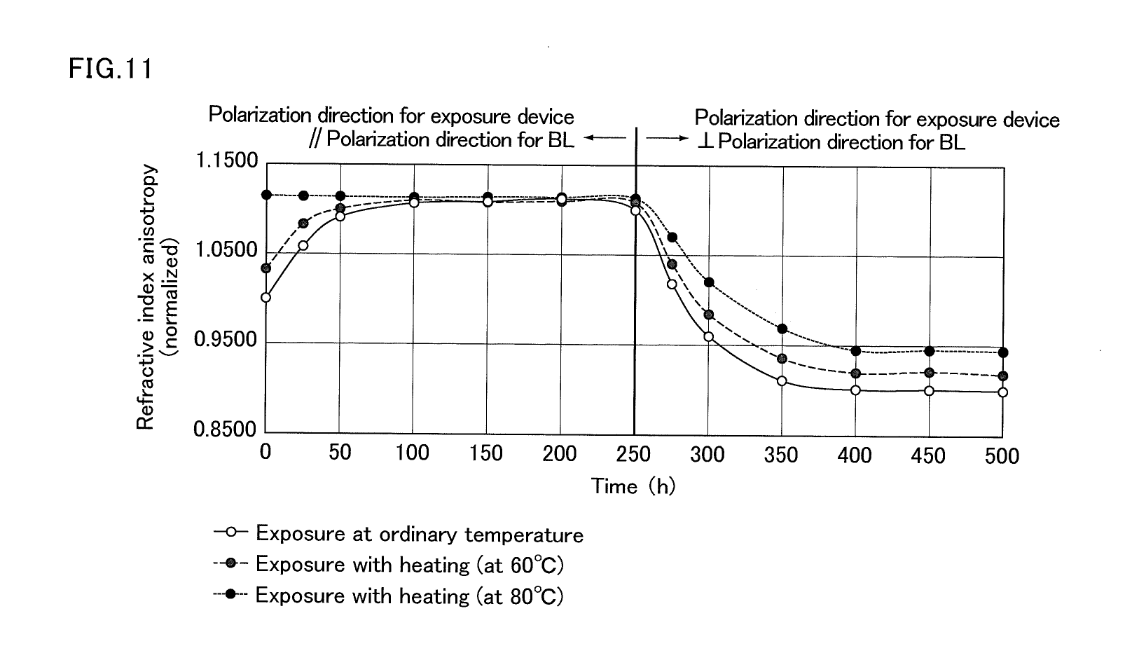

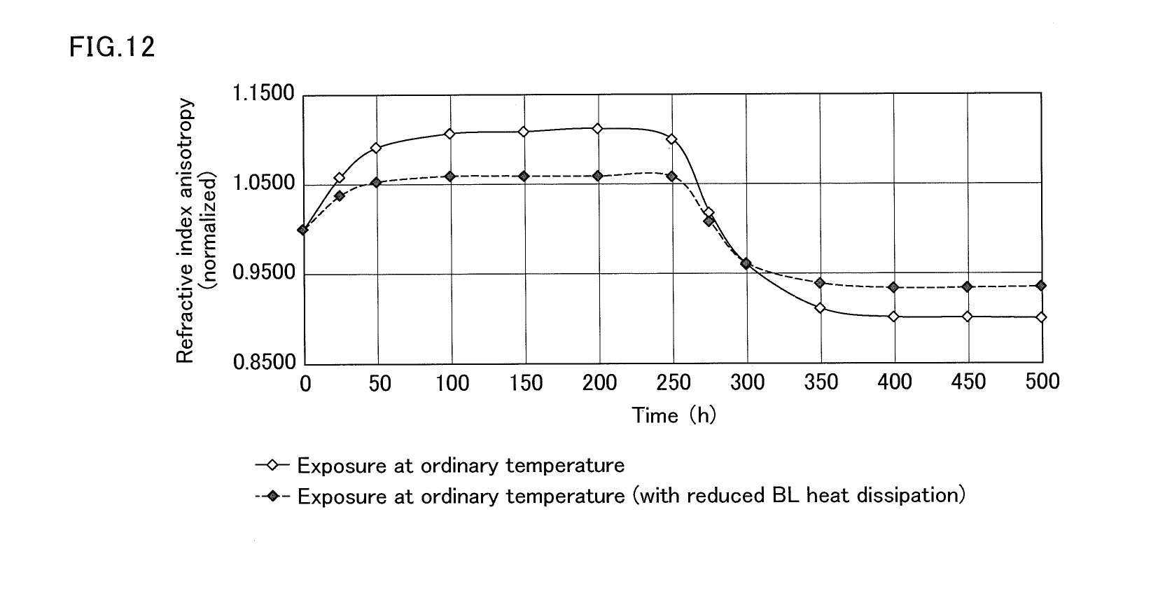

In polarized UV exposure as the photo-alignment treatment for the pre-baked glass substrate with an alignment film, no heating was performed in Example 1. In contrast, the photo-alignment treatment was performed while the glass substrate with an alignment film was heated to 80° C. in Example 2. Heating can increase the reactivity of molecules in the alignment film. The process of testing following the polarized UV exposure is also the same as that in Example 1, and description is not repeated here. FIG. 9 is a graph showing changes with time in refractive index anisotropies of alignment films when substrates with an alignment film in Example 2 and Comparative Example 2 are irradiated with polarized backlight illumination. The results are shown in the following Table 2 and FIG. 9.

TABLE 2

| Elapsed time (h) | 0 | 25 | 50 | 100 | 150 | 200 | 250 | 275 | 300 | 350 | 400 | 450 | 500 |
|---|---|---|---|---|---|---|---|---|---|---|---|---|---|
| Comparative | 1.1145 | 1.1140 | 1.1139 | 1.1132 | 1.1139 | 1.1138 | 1.1130 | 1.0701 | 1.0202 | 0.9689 | 0.9449 | 0.9451 | 0.9439 |
| Example 2 | | | | | | | | | | | | | |
| Example 2 (with | 1.1145 | 1.1140 | 1.1139 | 1.1132 | 1.1139 | 1.1138 | 1.1130 | 1.0911 | 1.0488 | 0.9913 | 0.9711 | 0.9689 | 0.9701 |
| heat-insulating | | | | | | | | | | | | | |
| layer) | | | | | | | | | | | | | |

### Comparative Example 2

The anisotropy of a substrate with an alignment film of Comparative Example 2 was measured as in Example 2, except that no spacer was disposed between the substrate with an alignment film and the polarizing plate in measurement of the anisotropy of the alignment film. In other words, no heat-insulating layer was used in Comparative Example 2. Here, the temperature of the surface of the substrate with an alignment film of Comparative Example 2 was higher than the temperature of the surface of the substrate with an alignment film of Example 2 by about 10° C. to 15° C. The illuminance of the transmitted light from the backlight, i.e., the illuminance of the light emitted from the backlight and transmitted though the polarizing plate, on the surface of the substrate with an alignment film, in Example 2 was the same as that in Comparative Example 2. The results are shown in Table 2 and FIG. 9.

### Comparison Between Example 2 and Comparative Example 2

Also in Example 2 and Comparative Example 2, changes with time were not observed and no significant difference was found when the polarization direction for the polarized UV exposure in the photo-alignment treatment and the polarization direction of polarized backlight irradiation were the same. The initial refractive index anisotropies in Example 2 and Comparative Example 2 were higher than the initial refractive index anisotropies in Example 1 and Comparative Example 1, respectively. This is the effect of polarized UV exposure performed with heating in the photo-alignment treatment.

In contrast, when the polarization direction for polarized UV exposure in the photo-alignment treatment and the polarization direction of polarized backlight irradiation were not the same, the decrease in refractive index anisotropy in Example 2 in which a heat-insulating layer was used is reduced as compared with that in Comparative Example 2. As described above, a correlation was found between the refractive index anisotropy and image sticking, and thus image sticking can be reduced in Example 2 even in long-term use.

The above results show that good quality can be maintained by adding heat in application of polarized light to align compounds in the alignment film in the desired direction, and by blocking heat to be applied simultaneously to light irradiation to the alignment film after the alignment treatment by polarized light application.

In Example 2, the substrate 301 with an alignment film, the heat-insulating layer 20, the polarizing plate PL1, and the backlight 14 were disposed in the given order. Yet, the heat-insulating layer 20 may be at any position where the heat-insulating layer 20 can reduce transfer of heat dissipated from the backlight 14 to the substrate 301 with an alignment film. Thus, the same results as in Example 2 should be achieved even in the case where the positions of the heat-insulating layer 20 and the polarizing plate PL1 in Example 2 were switched such that the substrate 301 with an alignment film, the polarizing plate PL1, the heat-insulating layer 20, and the backlight 14 were disposed in the given order.

What is claimed is:

1. A liquid crystal module comprising, in the following order from a back surface side, a backlight configured to emit light including visible light, a polarizing plate, a first substrate, a liquid crystal layer, and a second substrate,
the liquid crystal module further comprising:
a heat-insulating layer at least at one position selected from between the backlight and the polarizing plate and between the polarizing plate and the first substrate; and
an alignment film containing an azobenzene group on a liquid crystal layer side of at least one of the first substrate or the second substrate.

2. The liquid crystal module according to claim 1,
wherein the heat-insulating layer includes at least one layer selected from the group consisting of a heat-absorbing filter, an air layer, an inert gas layer, and a vacuum layer.
